(19) United States
(12) Patent Application Publication
(10) Pub. No.: US 2024/0212034 A1
(43) Pub. Date: Jun. 27, 2024

(54) INFORMATION PROCESSING DEVICE

(71) Applicant: TOYOTA JIDOSHA KABUSHIKI KAISHA, Toyota-shi (JP)

(72) Inventors: Yosuke NITTA, Kashiwa-shi (JP); Yu HAMADA, Nagoya-shi (JP); Yoichiro TOKAMI, Nagoya-shi (JP)

(73) Assignee: TOYOTA JIDOSHA KABUSHIKI KAISHA, Toyota-shi (JP)

(21) Appl. No.: 18/481,449

(22) Filed: Oct. 5, 2023

(30) Foreign Application Priority Data
Dec. 22, 2022 (JP) 2022-205857

(51) Int. Cl. G06Q 30/0645; G06Q 20/10

(52) U.S. Cl. CPC G06Q 30/0645; G06Q 20/10

(57) ABSTRACT

An information processing device includes a control unit that executes identifying a first vehicle to be used by a first user, accepting designation of a first vehicle component to be mounted on the first vehicle, and outputting a second amount that is a payment amount for each time in a case where a price for the first vehicle component is divided and paid based on a first amount that is a price for the first vehicle component, wherein when the first user concludes a lease contract and uses the first vehicle, the control unit sets an amount obtained by dividing the first amount by a predetermined value that is not related to a remaining period of the lease contract as the second amount.

### CROSS-REFERENCE TO RELATED APPLICATION

This application claims priority to Japanese Patent Application No. 2022-205857 filed on Dec. 22, 2022, incorporated herein by reference in its entirety.

### BACKGROUND

### 1. Technical Field

The present disclosure relates to a technology for outputting the cost of a vehicle component.

### 2. Description of Related Art

Japanese Unexamined Patent Application Publication No. 2010-146446 (JP 2010-146446 A) proposes a discarded vehicle purchase estimation system that performs an estimation appropriately reflecting the values of reusable components.

### SUMMARY

An object of one aspect of the present disclosure is to provide a technology for appropriately outputting an amount of money in a case of payment for the price of a vehicle component in installments.

An information processing device according to the one aspect of the present disclosure includes a control unit configured to: identify a first vehicle for use by a first user; receive designation of a first vehicle component to be mounted on the first vehicle; and output, based on a first amount of money that is a price of the first vehicle component, a second amount of money to be paid each time in a case of payment for the price of the first vehicle component in installments.

The control unit is configured to, when the first user uses the first vehicle under lease contract, set the second amount of money to an amount of money obtained by dividing a predetermined amount of money obtained based on the first amount of money by a predetermined value that is not related to a remaining period of the lease contract.

According to the one aspect of the present disclosure, it is possible to provide the technology for appropriately outputting the amount of money in the case of payment for the price of the vehicle component in installments.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of an information processing device according to a first embodiment;

FIG. 2 is a diagram illustrating an example of a component database;

FIG. 3 is a flowchart illustrating a process of calculating a cost of a vehicle component performed by the control unit according to the first embodiment; and

FIG. 4 is a diagram illustrating a flow of a process in which a control unit according to the second embodiment calculates a cost of a vehicle component;

### DETAILED DESCRIPTION OF EMBODIMENTS

In a case where a user attaches a vehicle component to a vehicle (hereinafter, also referred to as a leased vehicle) that enters into a lease contract and pays the price of the vehicle component in a split (for example, a monthly rate), it is conceivable that the total price is divided by the number of remaining months of the lease contract to be the amount per month. In this case, if the number of remaining months of the lease contract is small, compared with the case where the number of remaining months is large, in spite of the short period that can be used, an inappropriate situation that payments per month become expensive.

Therefore, in the information processing device according to the present embodiment, when the price of the vehicle component is divided and paid, the total price (first amount) of the vehicle component is divided by a predetermined value that is not related to the remaining period (remaining number of months) of the lease contract, and the payment amount per one time (for example, one month) (hereinafter, also referred to as a second amount, divided amount, or monthly amount) is calculated. Thus, the information processing device according to the present embodiment can appropriately determine the divided amount of the vehicle component regardless of the remaining period of the lease contract. For example, if a leased vehicle is sold as a used vehicle after the end of the lease agreement, the vehicle components worn during the lease agreement may be more valuable than if the vehicle components were not worn. Therefore, when the vehicle component is mounted on the leased vehicle, it is possible to obtain an appropriate division amount by dividing the total price amount of the vehicle component by a predetermined value that takes into consideration the value after the end of the lease contract, rather than the remaining period of the lease contract.

Hereinafter, specific embodiments of the present disclosure will be described with reference to the drawings. The hardware configuration, the functional configuration, and the like described in each embodiment are not intended to limit the technical scope of the disclosure to only those unless otherwise specified.

### First Embodiment

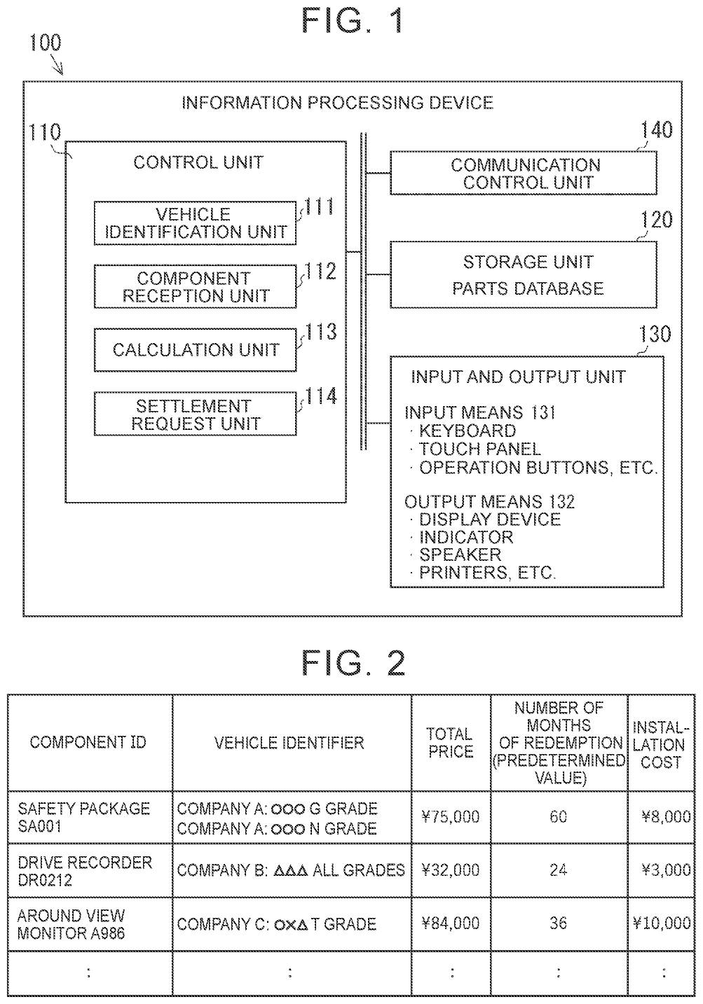

FIG. 1 is a diagram illustrating a configuration of an information processing device 100 according to the present embodiment. The information processing device 100 is a so-called computer including a control unit 110, a storage unit 120, an input/output unit 130, and a CCU (Communication Control Unit) 140. The control unit 110 includes a processor such as CPU (Central Processing Unit), DSP (Digital Signal Processor), or FPGA (Field-Programmable Gate Array), and a main storage unit such as Random Access Memory (RAM) or Read Only Memory (ROM). For example, the control unit 110 performs arithmetic processing of the input information and outputs a processing result to control elements such as the storage unit 120, the input/output unit 130, and the communication control unit 140.

The storage unit (secondary storage unit) 120 includes, for example, a volatile memory such as a RAM, a nonvolatile memory such as a ROM, a Erasable Programmable ROM (EPROM), a hard disk drive (HDD), or a storage medium such as a removable medium. Note that the removable medium is, for example, a disk recording medium such as a Universal Serial Bus (USB) memory, a Compact Disc (CD), a Digital Versatile Disc (DVD), or a Blu-ray (registered trademark) Disc (BD). The storage unit 120 may be configured using a computer-readable recording medium such as an externally attachable memory card.

The storage unit 120 can store an operating system (OS), various programs, various data tables, various databases, setting data, user data, and the like for executing operations of the information processing device 100. For example, the storage unit 120 may store a component database in which an identifier of a vehicle and information on a vehicle component that can be mounted on the vehicle are stored in association with each other. FIG. 2 is a diagram illustrating an example of a component database. In the component database of FIG. 2, for each component ID for identifying a vehicle component, an identifier of a vehicle on which the vehicle component can be mounted, a total price amount of the vehicle component, a predetermined value (the number of months of redemption), and an installation cost are registered. The predetermined value and the installation cost may be set differently for each vehicle component. The component database of FIG. 2 is an example, and is not limited to this data configuration.

The input/output unit 130 inputs information to the control unit 110 and outputs information from the control unit 110. The input/output unit 130 may include an input unit 131 that inputs information to the control unit 110, such as a keyboard, a touch panel, and an operation button. For example, the input unit 131 receives vehicle information, lease contract information, and the like by an operator of the information processing device 100. The input/output unit 130 may include an output unit 132 that outputs information to a user, such as a display device, an indicator, a speaker, and a printer. The input/output unit 130 may be an input/output interface that inputs information input from an external input unit to the control unit 110 and outputs information output from the control unit 110 to an external output unit.

The communication control unit 140 receives information from another device and transmits information to another device via a communication line. The communication line used by the communication control unit 140 is not particularly limited, and may be wired or wireless. The communication control unit 140 may use, for example, a public line such as the Internet, a mobile phone line, or a short-range wireless communication line. In addition, a plurality of communication control units 140 may be provided.

The control unit 110 reads a program stored in the storage unit 120 into a work area of the main storage unit, executes the program, and controls each element or the like, thereby functioning as a predetermined function unit, for example, a vehicle identification unit 111, a component reception unit 112, a calculation unit 113, and a settlement request unit 114. Note that the plurality of functional units is not limited to being realized by a single processor, and may be realized by a plurality of processors. Also, a single processor may implement a plurality of functional units by a technique such as multitasking or multithreading. Further, these functional units are not limited to those realized on the basis of a program (software), and some or all of them may be configured by hardware circuits such as a processor, an integrated circuit, and a logic circuit.

The vehicle identification unit 111 identifies a vehicle to be used by the user. The specific user is also referred to as a first user. The vehicle used by the first user is also referred to as a first vehicle.

The component reception unit 112 receives a designation of a vehicle component to be mounted on the vehicle. The vehicle component mounted on the first vehicle is also referred to as a first vehicle component.

The calculation unit 113 calculates a second amount (divided amount) that is a payment amount for each time in a case where the payment amount for the vehicle component is divided and paid based on the first amount that is the amount of the price for the vehicle component. Note that, in a case where the price is paid separately for each month, the second amount is also referred to as a monthly amount. For example, when the first user concludes a lease contract and uses the first vehicle, the calculation unit 113 calculates, as the second amount, an amount obtained by dividing the first amount by a predetermined value that is not related to the remaining period of the lease contract. Note that the calculation unit 113 is not limited to calculating the second amount of money, and may output the second amount of money by a process other than the calculation, such as obtaining and outputting the second amount of money corresponding to the first amount of money from the data table. In this case, the calculation unit 113 is also referred to as an amount output unit.

The settlement request unit 114 transmits the calculated amount to the settlement server to request settlement, thereby causing the settlement server to perform settlement.

### Accounting Method

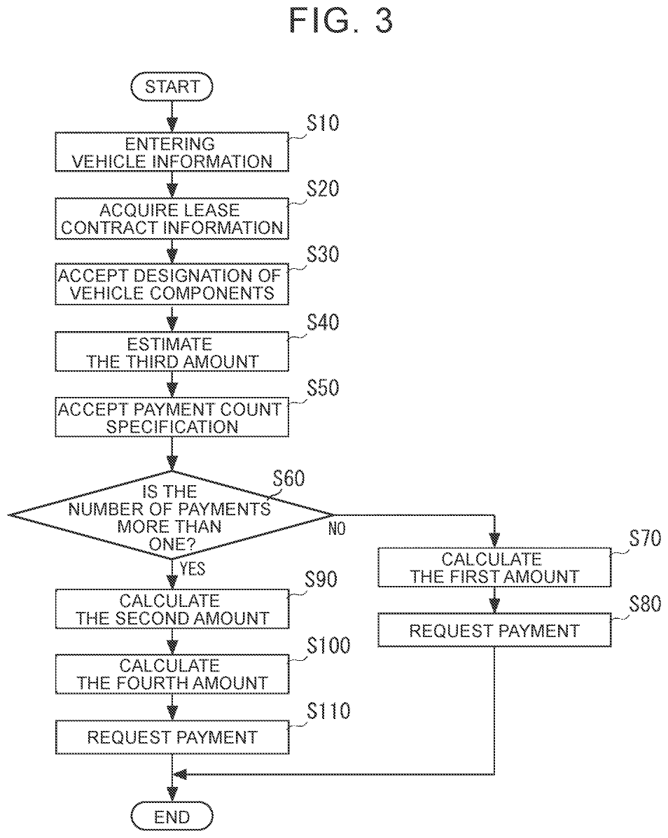

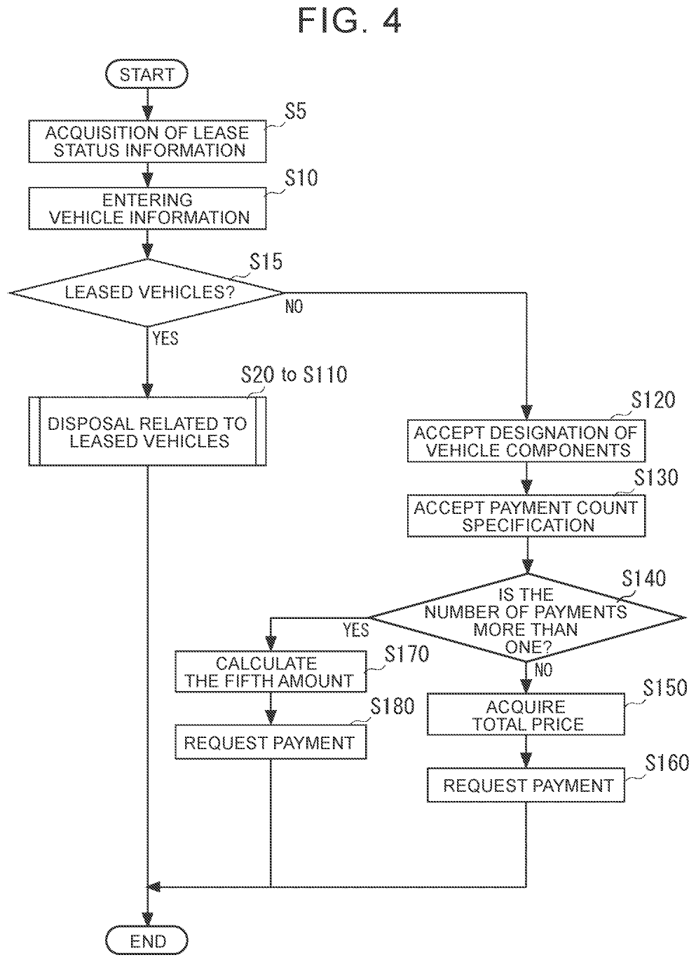

FIG. 3 is a diagram illustrating a flow of a process in which the control unit 110 calculates a cost of a vehicle component. The information processing device 100 according to the present embodiment executes the processing illustrated in FIG. 3, for example, when an operator of the information processing device 100 instructs to start the processing. The operator of the information processing device 100 may be, for example, a person in charge of the manufacturer who attaches the vehicle component or a user.

In S10, the control unit 110 identifies the first vehicle to be used by the first user by receiving the vehicle information from the operator or by reading the vehicle information from a device such as an Electronic Control Unit(ECU provided in the first vehicle. Here, the vehicle information is, for example, an identifier that can specify the specifications of the vehicle, such as a vehicle type, a year, a model number, a vehicle name, a grade, and a combination thereof.

In S20, the control unit 110 acquires information of a leasing contract related to the first vehicle. The information of the lease contract may include, for example, the start time of the lease, the number of remaining months of the lease, and the amount of the lease per month. The information of the lease contract may be registered in the storage unit 120 in advance, and may be acquired by reading from the storage unit 120, input by an operator via the input unit 131, or acquired from another device via a communication line. In the following steps, the information can be acquired by reading the information from the storage unit 120, inputting the information through the input unit 131, communicating with another device, or the like, as in S20.

In S30, the control unit 110 receives an input of information for designating a first vehicle component to be mounted on the first vehicle.

In S40, the control unit 110 estimates the value (third amount) of the first vehicle component at the time of expiration of the lease contract based on the information of the lease contract acquired by S20. For example, for a vehicle to which the first vehicle component is mounted and a vehicle to which the first vehicle component is not mounted, information indicating a change in price (current value) according to the year and month that has elapsed since the initial registration date is registered in the storage unit 120 in advance as market information. Then, the control unit 110 calculates (outputs) the difference between the price (current price) of the vehicle on which the first vehicle component is mounted and the vehicle on which the first vehicle component is not mounted as the third amount at the time of expiration of the lease contract based on the market information. The third method of calculating the amount of money is not limited thereto, and may be any method as long as the value of the first vehicle component at the time of expiration of the lease contract is determined. Note that S40 is not an essential step, and may be omitted when the third amount is not used in the subsequent step.

In S50, the control unit 110 receives input of information specifying the number of payments for the first vehicle component.

In S60, the control unit 110 determines whether the number of payments specified by S50 is plural. Here, when it is determined that the number of payments is not a plurality, that is, it is designated to pay collectively (negative determination), the control unit 110 proceeds to S70. In S70, the control unit 110 acquires the total price amount of the vehicle component from the component database of the storage unit 120, subtracts the third amount obtained by S40 from the total price amount, adds the installation cost, and calculates (outputs) the payment amount (first amount). Note that the installation cost may be determined for each type of vehicle component, and is acquired from, for example, a component database. Further, the installation cost may be set to a different amount of money in a case where the lease start date is later than the current time point, that is, in a case where the vehicle component is attached at the time of vehicle order and in a case where the vehicle component is attached after the lease start (in a case of retrofitting). For example, in a case where the vehicle component is mounted at the time of ordering, the mounting cost may be set to be lower than in the case of retrofitting, and the control unit 110 may determine whether to mount the vehicle component at the time of ordering or retrofitting based on the information of the lease contract, and may select the mounting cost.

In S80, the control unit 110 notifies the settlement server of an amount corresponding to the first amount determined by S70, requests the settlement, and causes the settlement server to perform the settlement process. Note that the amount corresponding to the first amount may be the same amount as the first amount, or may be an amount obtained by adding various expenses such as a settlement fee, a tax, and a system usage fee, or may be an appropriately adjusted amount such as an amount to which a discount is applied.

On the other hand, when it is determined (affirmative determination) that the number of payments is a plurality in S60, that is, when it is determined that it is designated to pay by division (for example, monthly rate), the control unit 110 proceeds to S90. In S90, the control unit 110 calculates a first amount of money in the same manner as S70, and calculates a second amount of money, which is the amount of money when the first amount is divided by a predetermined value and paid by a monthly rate. Here, the predetermined value is, for example, the number of redemption months read from the component database. Note that the predetermined value is not limited to the number of months of redemption. For example, the first amount may be divided by a value corresponding to an amount designated by the user, such as a monthly payment amount (second amount) of 1000 yen or 2000 yen. Further, the second amount obtained by S90 may be set higher than the first amount obtained by S70 by adding a division fee, an interest rate, or the like.

In S100, the control unit 110 calculates (outputs) a fourth amount by adding an amount corresponding to the second amount obtained by S90 to the monthly amount of the leased vehicles.

In S110, the control unit 110 notifies the settlement server of an amount corresponding to the fourth amount calculated by S100, requests the settlement, and causes the settlement server to perform the settlement process. Note that the amount corresponding to the fourth amount may be the same amount as the fourth amount, or may be an amount obtained by adding various expenses such as a settlement fee, a tax, and a system usage fee, or may be an appropriately adjusted amount such as an amount to which a discount is applied.

### Advantageous Effect of Embodiment

As described above, in the case where the price for the vehicle component is divided and paid, the information processing device 100 of the present embodiment outputs the monthly amount by dividing the first amount, which is the price for the vehicle component, by a predetermined value that is not associated with the remaining period (remaining number of months) of the lease contract. Thus, the information processing device 100 according to the present embodiment can appropriately determine the monthly amount of the vehicle component regardless of the remaining period of the lease contract.

Further, the information processing device 100 of the present embodiment estimates the third amount of money corresponding to the value of the first vehicle component at the time of expiration of the lease contract based on the information on the vehicle component, and divides the first amount obtained by subtracting the third amount of money by a predetermined value to obtain the second amount of money. Accordingly, the information processing device 100 of the present embodiment can reduce the amount of payment according to the value of the first vehicle component at the time of expiration of the lease contract, and can reduce the burden on the user.

### Second Embodiment

In the first embodiment described above, the cost in the case of attaching the vehicle component to the leased vehicle is calculated, but in the present embodiment, the cost in the case of attaching the vehicle component to the vehicle that is not the leased can be selectively calculated in addition to this. Since other configurations are the same as those of the first embodiment described above, the same elements are denoted by the same reference numerals, and description thereof will be omitted again.

FIG. 4 is a diagram illustrating a flow of processing performed by the control unit 110 according to the present embodiment to calculate a cost of a vehicle component. The information processing device 100 according to the present embodiment executes the processing illustrated in FIG. 4, for example, when an operator of the information processing device 100 instructs to start the processing.

In S5, the control unit 110 acquires information (lease status information) indicating whether or not the first vehicle is a vehicle (leased vehicle) related to a lease contract.

In S10, the control unit 110 identifies the first vehicle to be used by the first user by receiving the vehicle information from the operator or by reading the vehicle information from a device such as an Electronic Control Unit(ECU provided in the first vehicle.

In S15, the control unit 110 determines whether or not the first vehicle is a vehicle related to a leasing contract based on the information acquired by S5. If a negative determination is made in S15, the control unit 110 proceeds to S120 and receives input of information for designating the first vehicle component to be mounted on the first vehicle.

In S130, the control unit 110 receives input of information specifying the number of payments for the first vehicle component.

In S140, the control unit 110 determines whether or not the number of payments specified by S130 is a plurality of times. Here, if it is determined that the number of payments is not a plurality of times, that is, it is designated to pay collectively (negative determination), the control unit 110 proceeds to S150 and acquires the total price amount of the vehicle component from the component database of the storage unit 120.

In S160, the control unit 110 notifies the settlement servers of the amount corresponding to the total amount of the price determined by S150, and causes the settlement process to be performed. The amount corresponding to the total amount of the price may be the same amount as the total amount of the price, or may be an amount obtained by adding various expenses such as a settlement fee, a tax, and a system usage fee, or may be an appropriately adjusted amount such as an amount to which a discount is applied.

On the other hand, when it is determined that the number of payments is a plurality of times in S140, that is, when it is determined (affirmative determination) that it is designated to pay by division (for example, monthly rate), the control unit 110 proceeds to S170. In S170, the control unit 110 divides the total price amount acquired by S150 by a predetermined number of months (the number of times of payment), and calculates (outputs) a fifth amount of money, which is the amount of money when the payment is made on a monthly basis. In S170, the control unit 110 may calculate the fifth amount by adding a division fee, an interest rate, or the like to the total amount of money acquired by S150 and dividing the amount set to be higher than the amount of money to be charged by S160 by a predetermined number of months.

In S180, the control unit 110 notifies the settlement servers of the amount corresponding to the fifth amount obtained by S170, and causes the settlement to be performed. Note that the amount corresponding to the fifth amount may be the same amount as the fifth amount, or may be an amount obtained by adding various expenses such as a settlement fee, a tax, and a system usage fee, or may be an appropriately adjusted amount such as an amount to which a discount is applied.

If it is determined in S15 that the first vehicle is a vehicle for which a leasing contract has been concluded, that is, if the determination is affirmative, the control unit 110 proceeds to S20. The processes of S20 to S110 related to the leased vehicles are the same as that of the first embodiment described above.

As described above, the information processing device 100 of the present embodiment can appropriately output the payment amount of the vehicle component to be mounted between the case of the leased vehicle and the case of the non-leased vehicle. For example, if the first vehicle is not a leased vehicle, the payment amount may be determined in a conventional manner, and if the first vehicle is a leased vehicle, an appropriate payment amount may be calculated taking into account the value of the first vehicle component at the time of expiration of the lease contract. In particular, in a case where the price for the vehicle component is divided and paid, the information processing device 100 calculates the monthly amount by dividing the first amount, which is the price for the vehicle component, by a predetermined value that is not associated with the remaining period (remaining number of months) of the lease contract. Thus, the information processing device 100 according to the present embodiment can appropriately determine the monthly amount of the vehicle component regardless of the remaining period of the lease contract.

### Other Embodiments

The above-described embodiments are merely examples, and the present disclosure may be appropriately modified and implemented without departing from the scope thereof.

The processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. The computer system may realize each function by any hardware configuration (server configuration), and may be flexibly changeable.

The disclosure can also be implemented by providing a computer program in which the functions described in the embodiments are implemented to a computer, and by one or more processors included in the computer reading and executing the program. Such a computer program may be provided to the computer by a non-transitory computer-readable storage medium connectable to the system bus of the computer, or may be provided to the computer via a network. The non-transitory computer-readable storage medium includes any type of disk such as a magnetic disk (floppy (registered trademark) disk, hard disk drive (HDD), etc.) and an optical disc (CD-ROM, DVD disc, Blu-ray disc, etc.). The non-transitory computer readable storage medium also includes a read only memory (ROM), a random access memory (RAM), an EPROM, an EEPROM, a magnetic card, a flash memory, an optical card, and any other type of media suitable for storing electronic instructions.

What is claimed is:

1. An information processing device comprising a control unit configured to:
identify a first vehicle for use by a first user;
receive designation of a first vehicle component to be mounted on the first vehicle; and
output, based on a first amount of money that is a price of the first vehicle component, a second amount of money to be paid each time in a case of payment for the price of the first vehicle component in installments,
wherein the control unit is configured to, when the first user uses the first vehicle under lease contract, set the second amount of money to an amount of money obtained by dividing a predetermined amount of money obtained based on the first amount of money by a predetermined value that is not related to a remaining period of the lease contract.

2. The information processing device according to claim 1, further comprising a database configured to store an identifier of the vehicle and information on a vehicle component mountable on the vehicle in association with each other.

3. The information processing device according to claim 1, wherein the control unit is configured to:
estimate, based on information on the vehicle component, a third amount of money corresponding to a value of the first vehicle component at expiration of the lease contract; and
determine the second amount of money by dividing an amount of money obtained by subtracting the third amount of money from the first amount of money by the predetermined value.

4. The information processing device according to claim 1, wherein the control unit is configured to:
determine whether the first vehicle is a vehicle related to the lease contract;
when the first vehicle is the vehicle related to the lease contract, calculate a fourth amount of money by adding the second amount of money to a monthly lease fee related to the first vehicle, and notify a settlement server about the fourth amount of money; and
when the first vehicle is not the vehicle related to the lease contract, notify the settlement server about an amount of money corresponding to the first amount of money.

5. The information processing device according to claim 1, wherein the control unit is configured to:
receive selection as to whether to pay for the first vehicle component in a lump sum or in monthly installments;
when selection is made for payment in the lump sum, notify a settlement server to settle an amount of money corresponding to the first amount of money in the lump sum;
when selection is made for payment in the monthly installments, determine whether the first vehicle is a vehicle under the lease contract;
when the first vehicle is the vehicle under the lease contract, calculate a fourth amount of money by adding the second amount of money to a monthly lease fee related to the first vehicle, and notify the settlement server about an amount of money corresponding to the fourth amount of money; and
when the first vehicle is not the vehicle under the lease contract, calculate a fifth amount of money by dividing the first amount of money by a predetermined number of months, and notify the settlement server about an amount of money corresponding to the fifth amount of money.
